(19) United States
(12) Patent Application Publication
(10) Pub. No.: US 2009/0152758 A1
(43) Pub. Date: Jun. 18, 2009

(54) METHOD FOR PRODUCING DEHYDRATING SHEET

(75) Inventors: Kazuma Adachi, Oita-shi (JP); Toshinori Inomata, Higashikanbara-gun (JP); Katsunori Saito, Yokohama-shi (JP)

Correspondence Address: WOOD, HERRON & EVANS, LLP, 2700 CAREW TOWER, 441 VINE STREET, CINCINNATI, OH, 45202, US

(73) Assignee: OKAMOTO INDUSTRIES, INC., Tokyo (JP)

(21) Appl. No.: 12/295,810

(22) PCT Filed: Apr. 5, 2007
(86) PCT No.: PCT/JP2007/057647

§ 371 Date: Oct. 2, 2008

(30) Foreign Application Priority Data
Apr. 5, 2006 (JP) 2006-104057

(51) Int. Cl. B29C 55/02

(52) U.S. Cl. 264/171.1

(57) ABSTRACT

The present invention provides a method for producing a dehydrating sheet comprising two films at least one of which is a polyvinyl alcohol film, and a high osmotic pressure material interposed between the films, wherein the polyvinyl alcohol film is formed by a stretching treatment after extrusion molding, followed by a heat treatment at 150 to 250° C. and a water treatment. According to the present invention, it is possible to provide a dehydrating sheet comprising a polyvinyl alcohol film which has excellent water permeability, is prevented from forming pinholes, and is not significantly expanded or shrunk due to the absorption of water.

### TECHNICAL FIELD

The present invention relates to a method for producing a dehydrating sheet suitably used for dehydrating food such as meat or fish.

Priority is claimed on Japanese Patent Application No. 2006-104057, filed Apr. 5, 2006, the content of which is incorporated herein by reference.

### BACKGROUND ART

A dehydrating sheet which is in a constitution of including a high osmotic pressure material interposed between two sheets of water-permeable films is widely used in order to dehydrate food such as meat or fish or to absorb moisture-drops formed when thawing food (for example, refer to Japanese Unexamined Patent Application, First Publication No. H01-130730).

A water-permeable film employed for such the dehydrating sheet is required to have excellent water permeability and flexibility to easily adhere to food. Moreover, the water-permeable film needs to have superior heat-seal efficiency, since a method of heat sealing fringe parts of the water-permeable films is usually adopted so as to enclose a high osmotic pressure material between two sheets of the water-permeable films. In addition, the water-permeable film should not have a pinhole in order to prevent the enclosed high osmotic pressure material from coming out. Consequently, a polyvinyl alcohol film having a thickness between 5 and 50 μm is generally used as a water-permeable film as it readily meets the foregoing requirements. Hereinafter, polyvinyl alcohol is abbreviated as “PVA.”

As a method for producing a PVA film with the aforementioned thickness, there have been known an extrusion molding method in which a PVA aqueous solution with high viscosity is extruded to form a film followed by drying, and the film is stretched to be adjusted to a desired thickness, and heated; and a solution casting method in which a PVA aqueous solution is cast on a rotating drum or belt through a slit or coated by a roll coater, followed by evaporating moisture and applying heat treatment, to form a film.

However, even if a PVA film produced by a solution casting method has superior water permeability as compared to the one produced by an extrusion molding method, it has a problem that if it is used for a dehydrating sheet, it accordingly swells and expands as it absorbs moisture. When such the expanding occurs, creases are formed on the surface of the PVA film, which may be transferred to the surface of an object to be dehydrated, i.e., the surface of food that is in contact with the PVA film. Thus, the appearance of food may not be favorable for the user.

Moreover, in the solution casting method, since a film is formed by thinly casting or coating a PVA aqueous solution, there may be a case where a pinhole is formed on an obtained PVA film. If a PVA film with a pinhole is used for a dehydrating sheet, a high osmotic pressure material enclosed in the dehydrating sheet comes out of the pinhole and the dehydrating sheet may become sticky.

On the other hand, a PVA film produced by an extrusion molding method is formed by stretching a thick film into a thin film. Thus, a pinhole hardly forms; however, water permeability is not good. Accordingly, there has been a problem in that a dehydrating sheet employing such the PVA film has a slow rate for dehydrating food.

In addition, the PVA film formed by an extrusion molding method tends to shrink significantly by the absorption of water, and thus a dehydrating sheet employing such the PVA film is likely to come off from the surface of food during its use.

The present invention has been made in consideration of the above circumstances, and an object of the invention is to provide a dehydrating sheet including a PVA film which has excellent water permeability, is prevented from forming pinholes, and does not significantly expand or shrink due to the absorption of water.

### DISCLOSURE OF THE INVENTION

As a result of extensive studies, the inventors of the present invention found that a PVA film, which is formed by a stretching treatment after extrusion molding, followed by a heat treatment and a water treatment, has improved water permeability and does not significantly shrink by the absorption of water. Accordingly, the present invention was achieved.

According to the invention, in a method for producing a dehydrating sheet having two films at least one of which is a PVA film and a high osmotic pressure material interposed between the films, the PVA film is characterized in that it is formed by a stretching treatment after extrusion molding, followed by a heat treatment at 150 to 250° C., and a water treatment.

The water treatment is preferably carried out at a temperature of 10 to 50° C.

According to the invention, a dehydrating sheet including a PVA film which has excellent water permeability, is prevented from forming pinholes, and does not significantly expand or shrink due to the absorption of water can be provided.

### BRIEF DESCRIPTION OF THE DRAWINGS

FIG. 1 is a cross-sectional view illustrating an example of a dehydrating sheet produced by the present invention.

FIG. 2 is a process view illustrating an example of process after a water treatment in the producing method of the present invention.

### REFERENCE NUMERALS

10: dehydrating sheet
11. PVA film
12: high osmotic pressure material

### BEST MODE FOR CARRYING OUT THE INVENTION

Hereinafter, certain exemplary embodiments of the present invention will be described in detail.

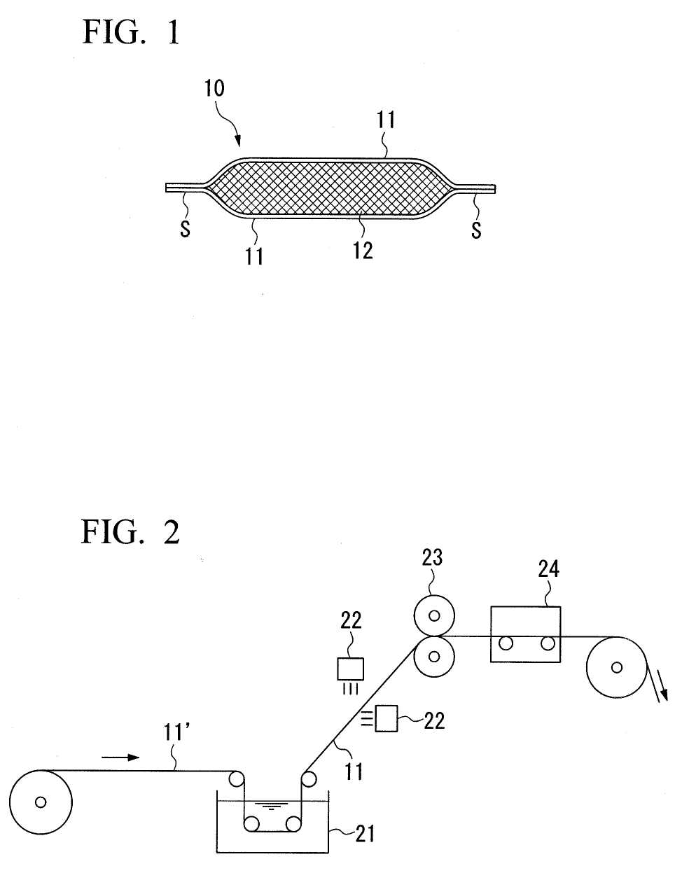

FIG. 1 shows an illustrative example of a dehydrating sheet manufactured by a producing method of the present invention. A dehydrating sheet 10 includes two sheets of PVA films 11 of which fringe parts S are sealed to each other, and a high osmotic pressure material provided between the PVA films 11.

The PVA films 11 constituting the dehydrating sheet 10 are produced by a stretching treatment after extrusion molding, followed by a heat treatment at 150 to 250° C., and a water treatment for the stretched PVA film.

In the following, an illustrative example of a method for producing the PVA films 11 will be described in detail.

First, a PVA aqueous solution is prepared and extruded to form a film. Then, the film is stretched and additionally treated with heat to settle the arrangement of molecules by the stretching, thereby producing a stretched PVA film.

Here, PVA may be produced by a known method. For example, a vinyl ester-based compound such as vinyl acetate is polymerized, as necessary, with other vinyl monomers by a known polymerization method to form a vinyl ester-based polymer, after which the polymer is saponified by an alkali such as sodium hydroxide (NaOH), thereby producing the PVA. In this case, other vinyl monomers may be used preferably by about 0.5 to 10 mole % based on the total amount with the vinyl ester-type compound. A saponification degree is preferably 90 mole % or more.

Further, the PVA has a viscosity of preferably 2.5 to 100 mPa·s (20° C.), more preferably 2.5 to 70 mPa·s (20° C.), and still more preferably 2.5 to 60 mPa·s (20° C.), according to the measurement by JIS K6726 in case of 4 mass % of an aqueous solution. Within the foregoing range, a PVA film 11 to be finally obtained has good film forming properties as well as excellent film strength.

If sodium hydroxide is used as an alkali in saponification, an obtained PVA may include impurities such as sodium acetate. In this case, the content of sodium acetate in the PVA is preferably 0.8 mass % or less and more preferably 0.5 mass % or less from the viewpoints of heat resistance and prevention of coloration for a PVA film 11 to be finally obtained.

The PVA concentration in the PVA aqueous solution is not limited to a specific value, but is preferably from 5 to 70 mass % and more preferably from 10 to 60 mass %.

Moreover, the aqueous solution may, as necessary, include polyvalent alcohols such as ethylene glycol, glycerin, polyethylene glycol, diethylene glycol, and triethylene glycol, phenol-based or amine-based antioxidants, stabilizers such as phosphate esters, and general additives such as coloring agents, perfumery, bulking agents, antifoaming agents, release agents, ultraviolet absorbents, inorganic powder, surfactants, or the like. In addition, the aqueous solution may include a water-soluble resin such as starch, carboxyl methyl cellulose, methyl cellulose, and hydroxyl methyl cellulose, in addition to polyvinyl alcohol.

An illustrative extrusion molding method may be exemplified by a method of extruding a PVA solution on a cast roll from an extruder equipped with a T die. A melt-kneading temperature is preferably from 55 to 140° C. and more preferably from 55 to 130° C. Within the foregoing temperature range, a film having a fine surface without bubbles can be formed. After the extrusion molding, the film is dried at preferably 70 to 120° C. and more preferably 80 to 100° C. Within the aforementioned temperature range, drying can be moderately carried out without requiring a long period of time. A thus obtained un-stretched PVA film before a stretching treatment has a thickness of preferably 40 to 1300 μm.

Next, the un-stretched film is stretched to be a thin film having a thickness of preferably 5 to 50 μm and more preferably 10 to 30 μm by a stretching treatment. By making it thin to such a degree, the PVA film 11 to be finally obtained exhibits even greater water permeability, flexibility and heat sealing properties. Then, a heat treatment is carried out to settle the arrangement of molecules by the stretching treatment, thereby producing a stretched PVA film.

The stretching treatment may either be conducted with mono-axial stretching or biaxial stretching. However, biaxial stretching is more preferable from the viewpoint of producing a stretched PVA film with a thickness providing excellent water permeability and flexibility. As biaxial stretching, both sequential biaxial stretching and simultaneous biaxial stretching can be employed. Before the biaxial stretching, the un-stretched film, produced by extrusion molding, may be adjusted to have a water content of preferably 5 to 30 mass % and more preferably 20 to 30 mass %, thereby sufficiently increasing the stretching ratio. For adjusting the water content, there can be employed a method of appropriately setting the conditions for the foregoing drying treatment or a method in which the one having a water content of 5 mass % or less is brought into contact with water by immersing into or spraying with water thereby adjusting the water content to be between 5 and 30 mass %.

The stretching ratio is not limited to a specific value. In case of biaxial stretching, however, the stretching ratio is preferably three to five times and more preferably three to four and a half times in the lengthwise direction (the direction in which a film is extruded), and is preferably three to five times and more preferably three to four times in the widthwise direction. Within the range, the PVA film 11 having a desired thickness and excellent water permeability and flexibility can be readily obtained. Furthermore, problems such as the film being torn or destroyed during the stretching treatment hardly occur.

After the stretching treatment, the heat treatment is carried out at 150 to 250° C., preferably 150 to 230° C., and more preferably 160 to 200° C. Below 150° C., a sufficient settling effect cannot be obtained, and a dimensional stability of the PVA film 11 to be finally obtained deteriorates. As a result, in the case of using it for a dehydrating sheet, the PVA film 11 may significantly shrink due to the absorption of water. Meanwhile, over 250° C., the thickness of the PVA film 11 to be finally obtained may significantly vary or a dehydrating sheet employing this PVA film 11 may have low water permeability thereby lowering a dehydrating speed. The heat treatment is carried out for preferably 1 to 30 seconds and more preferably 5 to 10 seconds.

The stretched PVA film that had been heat treated in such a manner is then subjected to a water treatment, which suitably alleviating a molecular arrangement obtained from stretching treatment. As a result, a PVA film 11 exhibiting excellent water permeability while giving no significant shrinkage by water absorption can be obtained. Furthermore, since the PVA film 11 obtained in such a manner is obtained by forming a thick film by extrusion molding, followed by stretching into a thin film, pinholes hardly form.

An illustrative water treatment is preferably exemplified by, as shown in FIG. 2, a method comprising successively transferring the stretched PVA film 11′ that had been treated with heat, to a tank 21 with water of 10 to 50° C., and immersing thereafter. An immersing time is preferably 3 to 180 seconds and more preferably 10 to 120 seconds. If the immersing time is within this range, the degree of alleviating the arrangement of molecules become appropriate, and thus a PVA film 11 having excellent water permeability while giving no significant shrinkage by water absorption can be easily obtained.

After the water treatment, a drying treatment is preferably carried out to enhance the blocking resistance of the PVA film 11. As the drying method, there is a method of blowing off moisture on the surface of the film using an air shower 22; a method of removing water by placing the PVA film 11 between nip rolls 23; and a method of using a drier 24. These may also be sequentially carried out as illustrated in FIG. 2. When using the drier 24, a drying temperature is preferably 40 to 150° C. and more preferably 60 to 120° C. Also, the drying period is preferably five seconds to five minutes and more preferably ten seconds to three minutes. Within these drying temperatures and time ranges, a PVA film 11 having proper water content and excellent blocking resistance can be obtained without deteriorating processing properties of the film due to insufficient or excessive drying. If the PVA film 11 has excellent blocking resistance, problems such as breakage of films upon peeling as they stick to each other when it is once wound into a roll hardly occur.

As the drier 24, a drier equipped with a heating roller such as a metal roller or ceramic roller can be used which directly comes in contact with the PVA film 11, but more preferred is a non-contacting type drier which conducts drying using heated air. In addition, it is preferable to use a hot-air drier which blows heated air to the film rather than a drier in which a heater and the PVA film 11 are disposed to face each other.

In addition, shower washing (not shown) in which the surface of the PVA film 11 is shower washed with water may be carried out between the water treatment and the drying treatment.

A high osmotic pressure material 12 is placed on one side of the thus obtained PVA film 11, another PVA film 11 is stacked thereon, and the fringe parts S of the two sheets of PVA films 11 are sealed to each other to enclose the high osmotic pressure material 12 therein, thereby producing a dehydrating sheet 10 shown in FIG. 1.

Alternatively, the high osmotic pressure material 12 is intermittently placed on the PVA film 11, and another PVA film 11 is stacked thereon. Then, the two sheets of PVA films 11 are sealed to enclose intermittently placed high osmotic pressure materials 12, thereby producing a continuum of dehydrating sheets 10 inside which the high osmotic pressure materials 12 are enclosed. In this case, the obtained continuum is separated into the respective dehydrating sheets 10 by a cutter to produce the individual dehydrating sheets 10 the fringe part S of which is sealed to have the high osmotic pressure material 12 therein.

The high osmotic pressure material 12 is not limited to a specific kind as long as it has a dehydrating capability to absorb moisture in food or moisture-drips from food. For example, the high osmotic pressure material 12 includes an aqueous solution of sugars having an osmotic pressure of 10 atmospheric pressure or more such as starch syrup, sugar, isomerized sugar, glucose, fructose, mannitol, sorbitol, reduced starch syrup, etc., glycerin, propylene glycol, or the like. If the foregoing materials are used as the high osmotic pressure material 12, an aqueous thickener solution is preferably added thereto, as disclosed in Japanese Examined Patent Application, Second Publication No. H04-033491, in order to maintain the constant viscosity even when the high osmotic pressure material 12 is absorbed.

Furthermore, a method of sealing the fringe parts S of the PVA film 11 is not particularly limited. However heat sealing by a bar sealer, an impulse sealer, and a high-frequency sealer may be used in addition to using a bonding agent.

The PVA film 11 comprised in the dehydrating sheet 10 produced in such a manner is a film obtained by performing a stretching treatment after extrusion molding, followed by subjecting a stretched PVA film 11′ that had been heat treated to a water treatment. Thus, this film exhibits excellent water permeability while giving no significant expansion or shrinkage by water absorption and is prevented from forming pinholes. Therefore, the dehydrating sheet 10 can dehydrate food at a high dehydrating speed or absorb moisture-drips from food in thawing process, without causing problems such as transferring crease formed due to expansion of PVA film 11 on the surface of food to be dehydrated thereby affecting the appearance of food; coming off from the food upon its use; and causing stickiness by high osmotic pressure materials 12 leaking out of pinholes on a PVA film 11.

The foregoing description has been made with an illustrative example of the dehydrating sheet 10 which is formed of the two sheets of PVA films 11 and the high osmotic material 12 interposed therebetween. However, it is fine as long as the dehydrating sheet is formed of a PVA film 11 on at least one side, and for the other side, other water-permeable film, a non water-permeable film, a mount or the like can be used.

In addition, the foregoing description has also been illustrated with a method for producing a film by extrusion molding, in which a PVA aqueous solution is prepared in advance and supplied to an extruder to conduct extruding. Alternatively, if uniform mixing is possible, PVA, water and, if necessary, other additives are put into an extruder to prepare a PVA-film aqueous solution in the extruder, and the solution is extruded. For uniform mixing, for example, the extruder may be adjusted to have greater L/D, a polyaxial extruder may be used, or a gear pump may be employed. In other embodiments, the PVA aqueous solution is dried once to obtain pellets or flakes of PVA, which are formed into a film by an extruder.

In using the obtained PVA film for a dehydrating sheet, the PVA film may be embossed to impart blocking resistance or form a design. If the blocking resistance is enhanced, the PVA film does not stick to each other but easily taken off by one sheet even when a plurality of films are overlapped.

### EXAMPLES

Hereinafter, the present invention will be described in detail with reference to examples.

### Example 1

### Preparation of PVA Film

40 parts by mass of PVA (a 4 mass % aqueous solution thereof has a viscosity of 40 mPa·s, a saponification degree of 99.7 mole %, and an sodium acetate content of 0.3%) were dissolved in 60 parts by mass of water to prepare a PVA aqueous solution. The PVA aqueous solution was supplied by a quantifying pump into a biaxial extruding kneader (screw L/D=40) having a jacket temperature of 60 to 150° C. from a hopper of the kneader, and was kneaded and discharged. The discharge amount was 500 kg/h.

Next, the discharge material (PVA aqueous solution) was immediately sent to a mono-axial extruder (screw L/D=30) while being pressed, and kneaded at 85 to 140° C. Then, the solution was extruded to a cast roll of 5° C. from a T die and dried by a heat-air drier of 90° C. for 30 seconds, thereby producing an un-stretched PVA film having a water content of 25 mass % and a thickness of 150 μm.

Then, the film was stretched four times in the lengthwise direction, and then stretched four times by a tenter in the widthwise direction, followed by an additional heat treatment at 180° C. for 8 seconds, thereby producing a stretched PVA film having a thickness of 14 μm.

Subsequently, the stretched PVA film was immersed in a tank with 30° C. water for 30 seconds to obtain a PVA film. After the water treatment, the PVA film was shower washed with water having a flux of 100 m/sec to wash the surface of the PVA film. The PVA film was then showered with air of 50° C. blown at a speed of 30 m/min from a 3 mm-wide slit to remove moisture on the surface of the PVA film, and the PVA film was further interposed between nip rolls to be dehydrated. Thereafter, the PVA film was dried in a hot-air circulation drier adjusted to 100° C. for two minutes. The PVA film had a water content of 2.8 mass % and a thickness of 14 μm.

(Preparation of Dehydrating Sheet)

80 mass % of a fructose/glucose sugar solution, as a high osmotic pressure material, was intermittently applied to the PVA film obtained as above, and another sheet of the same PVA film was put thereon. The sugar solution was applied by 57 g to a 53 cm×37 cm portion of the PVA film 11.

Next, the two sheets of PVA films were sealed by heating each other at 220° C. and 0.4 MPa for 0.4 seconds to seal applied sugar solutions therein. Then, heat-sealed portions were cut and separated to produce a plurality of dehydrating sheets in 53 cm×37 cm.

Minced horse mackerel was interposed between two sheets of the obtained dehydrating sheets and left at 4° C. overnight, thereby preparing dried horse mackerel.

(Evaluation)

Hereinafter, evaluation was carried out as follows.

1. Shrinkage Ratio of Dehydrating Sheet According to Absorption of Water

The length and the width of the dehydrating sheets were measured before being used for enclosing minced horse mackerel therein and after having been used for enclosing minced horse mackerel therein and kept at 4° C. overnight to calculate shrinkage ratios. The shrinkage ratios (%) are shown in the table. Here, the lengthwise direction referred to a direction in which a PVA film was extruded, and the widthwise direction referred to a direction perpendicular thereto.

2. Pinhole

1000 sheets of dehydrating sheets, which had not been used for enclosing minced horse mackerel therein, were examined by the naked eye on whether pinholes occurred or not. The number of dehydrating sheets in which pinholes were found is shown in the table.

3. Dehydration Ratio of Minced Horse Mackerel

A decrease in the weight of the horse mackerel which had been left at 4° C. overnight was subtracted from the weight of the minced horse mackerel which had not been left overnight, which is expressed as a dehydration ratio (%) in the table.

4. Appearance of Minced Horse Mackerel

The dehydrating sheets were taken off from the minced horse mackerel after having been left at 4° C. overnight. Then, the appearance of the minced horse mackerel was observed with the naked eye. Results evaluated by the following standards are shown in the Table.

1: The appearance was the same as before the experiment and good.

2: The appearance was shinier than before the experiment but good.

3: The creases on the dehydrating sheet were transferred to the surface of the minced horse mackerel.

4: The flesh of minced horse mackerel was crumbled.

### Examples 2 to 6

A PVA film was prepared by a similar process to Example 1 except that the water temperature, the amount of time in the water treatment, and the conditions of a hot-air drier in the drying treatment were changed as illustrated in the following table, thereby producing a dehydrating sheet. Then, evaluation was performed as in Example 1. The results are shown in the following table.

### Comparative Example 1

A dehydrating sheet was prepared using a non-stretched PVA film having a thickness of 18 μm, which was produced by a solution casting method and is available on the market, and evaluated as in Example 1. The result is shown in the following table.

### Comparative Example 21

A PVA film was prepared by carrying out only the processes up to the heat treatment, without the subsequent processes including a water treatment. The heat treatment was carried out at 250° C. for 8 seconds. Except for the aforementioned, the PVA film was prepared as in Example 1 to produce a dehydrating sheet. Then, evaluation was performed as in Example 1. The result is shown in the following table.

### Comparative Example 3

A PVA film was prepared in the same manner as in Example 1 except that only the processes up to the heat treatment were carried out but the subsequent processes including a water treatment were not, thereby producing a dehydrating sheet. Then, evaluation was performed as in Example 1. The result is shown in the following table.

### Comparative Example 4

The non-stretched PVA film, used in Comparative Example 1, was subjected to the subsequent processes including a water treatment as in Example 1. Except for using the obtained PVA film, a dehydrating sheet was produced and evaluated as in Example 1. The result is shown in the following table.

### Comparative Example 5

A PVA film was prepared in the same manner as in Example 1, except for a temperature of 270° C. in a heat treatment, to produce a dehydrating sheet. Then, evaluation was performed as in Example 1. The result is shown in the following table.

TABLE 1

| | Preparation Conditions of PVA Film | | | | | | | | | | | | |
|---|---|---|---|---|---|---|---|---|---|---|---|---|---|
| | | | Heat | | | | Drying Treatment | | Evaluation | | | | |
| | Stretching | | Treatment | | Water | | after Water | | Shrinkage | | | Minced Horse | |
| | Treatment | | Tem- | | Treatment | | Treatment | | Ratio | | | Mackerel | |
| | Length | Width | perature | Time | Temperature | Time | Temperature | Time | Length | Width | Pinhole | Dehydration | |
| | (times) | (times) | (° C.) | (sec) | (° C.) | (sec) | (° C.) | (min) | (%) | (%) | (sheet) | Ratio (%) | Appearance |
| Example 1 | 4 | 4 | 180 | 8 | 30 | 30 | 100 | 2 | 0 | 0 | 0 | 10 | 1 |
| Example 2 | 4 | 4 | 180 | 8 | 5 | 30 | 100 | 2 | 10 | 10 | 0 | 10 | 2 |
| Example 3 | 4 | 4 | 180 | 8 | 70 | 30 | 100 | 2 | 0 | 0 | 0 | 10 | 1 |
| Example 4 | 4 | 4 | 180 | 8 | 30 | 3 | 100 | 2 | 7 | 7 | 0 | 11 | 2 |
| Example 5 | 4 | 4 | 180 | 8 | 30 | 30 | 30 | 2 | 0 | 0 | 0 | 10 | 1 |
| Example 6 | 4 | 4 | 180 | 8 | 30 | 30 | 100 | 3 sec | 0 | 0 | 0 | 10 | 1 |
| Comparative | No | | — | — | — | — | — | — | −11 | −11 | 3 | 10 | 3 |
| Example 1 | stretching | | | | | | | | | | | | |
| Comparative | 4 | 4 | 250 | 8 | — | — | — | — | 0 | 0 | 0 | 2 | 1 |
| Example 2 | | | | | | | | | | | | | |
| Comparative | 4 | 4 | 180 | 8 | — | — | — | — | 50 | 50 | 0 | — | 4 |
| Example 3 | | | | | | | | | | | | | |
| Comparative | No | | — | — | 30 | 30 | 100 | 2 | −9 | −9 | 3 | 10 | 3 |
| Example 4 | stretching | | | | | | | | | | | | |
| Comparative | 4 | 4 | 270 | 8 | 30 | 30 | 100 | 2 | 0 | 0 | 0 | 2 | 1 |
| Example 5 | | | | | | | | | | | | | |

In the respective examples, as illustrated in Table 1, the PVA films to be used for the dehydrating sheets had excellent water permeability, thereby producing the dehydrating sheets with the high dehydration ratios. In the dehydrating sheets, the formation of pinholes was prevented and a significant shrinkage due to water absorption did not occur. Moreover, since the dehydrating sheets were not significantly expanded according to use, creases did not form and a poor appearance due to the transfer of creases to the horse mackerel was also not found. However, when a water treatment was conducted at a low temperature or in a short period of time, the dehydrating sheet was slightly shrunk (Examples 2 and 4). When the water treatment was conducted at a high temperature, there was a phenomenon in which the stretched PVA film gradually stretches during the water treatment (Example 3). Besides, when a drying treatment after the water treatment was carried out at a low temperature or in a short period of time, the obtained PVA film had a tendency to cause slight blocking (Examples 5 and 6).

Meanwhile, the dehydrating sheets using a PVA film produced by a solution casting method in Comparative Examples 1 and 4 were significantly expanded upon use thereby forming creases, which were transferred to the horse mackerel. In Comparative Example 2, in which the heat treatment was conducted at 250° C. and a water treatment was not conducted, poor water permeability and a dehydration ratio were given. In Comparative Example 3, in which the heat treatment was conducted at a lower temperature than in Comparative Example 2 and a water treatment was not conducted, even if water permeability was exhibited, the dehydrating sheet was significantly shrunk during use and the flesh of minced horse mackerel was crumbled. In Comparative Example 5, in which the heat treatment was carried out at a high temperature, water permeability did not improve even after a water treatment and a sufficient dehydration ratio was not given.

1. A method for producing a dehydrating sheet comprising: two films at least one of which is a polyvinyl alcohol film; and a high osmotic pressure material interposed between the films,
wherein the polyvinyl alcohol film is formed by a stretching treatment after extrusion molding, followed by a heat treatment at 150 to 250° C. and a water treatment.

2. The method for producing the dehydrating sheet according to claim 1, wherein the water treatment is carried out at a temperature of 10 to 50° C.
